(19) United States
(12) Patent Application Publication
(10) Pub. No.: US 2015/0266428 A1
(43) Pub. Date: Sep. 24, 2015

(54) VEHICLE ARTICLE HOLDER

(71) Applicant: HONDA ACCESS CORP., Niiza-shi (JP)

(72) Inventor: Kaori Ishikawa, Niiza-shi (JP)

(73) Assignee: HONDA ACCESS CORP., Niiza-shi (JP)

(21) Appl. No.: 14/518,171

(22) Filed: Oct. 20, 2014

(30) Foreign Application Priority Data
Mar. 19, 2014 (JP) 2014-056983

(51) Int. Cl. B60R 7/04; B60R 7/12

(52) U.S. Cl. CPC B60R 7/04; B60R 7/12; B60R 2011/0059

(57) ABSTRACT

In a vehicle article holder detachably attached to vehicle equipment having a gripped portion and being installed at a predetermined position inside a vehicle, the holder includes a holder main body having a holding portion capable of detachably holding an article; a fixation body adjacent to and fixed to the main body and having a clamping portion capable of clamping part of the gripped portion of the equipment; and a lever body connected to the fixation body to be able to open and close the clamping portion. The fixation body, lever body, and main body are formed in such shapes that, in a state where an arbitrary part of the gripped portion is clamped by the clamping portion, another part thereof can be manually gripped. Accordingly, even when the holder is fixed to the gripped portion, a grip function of the gripped portion is not impaired.

### CROSS REFERENCE TO RELATED APPLICATIONS

The present application claims priority under 35 U.S.C. §119 to Japanese Patent Application No. 2014-56983 filed Mar. 19, 2014 the entire contents of which are hereby incorporated by reference.

### TECHNICAL FIELD

The present invention relates to a vehicle article holder detachably attached to vehicle equipment which has a gripped portion grippable by a person's hand and which is installed at a predetermined position in a vehicle compartment.

### BACKGROUND OF THE INVENTION

As an example of the vehicle article holder described above, there is known an umbrella holder detachably fixed to an assist grip which is vehicle equipment near a sliding door (see Japanese Patent Laid-open No. 2001-1760).

### SUMMARY OF THE INVENTION

However, in the conventional umbrella holder described above, an attachment bracket, which is a fixation body used to fix the umbrella holder to the assist grip, is formed as a relatively large component blocking an opening portion of the grip. Accordingly, in a state where the attachment bracket is fixed to the assist grip, there is a risk that an original grip function of the assist grip is impaired and the grip cannot be appropriately gripped by a person's hand.

According to a first aspect, there is provided a vehicle article holder detachably attached to vehicle equipment which has a gripped portion grippable by a person's hand and which is installed at a predetermined position in a vehicle compartment, the vehicle article holder comprising: a holder main body having a holding portion capable of detachably holding an article; a fixation body arranged adjacent to and fixed to the holder main body and having a clamping portion capable of clamping part of the gripped portion of the vehicle equipment; and a lever body provided continuously with the fixation body so as to be able to open and close the clamping portion, wherein the fixation body, the lever body, and the holder main body are formed in such shapes that, in a state where an arbitrary part of the gripped portion is clamped by the clamping portion, another part of the gripped portion can be gripped by the hand.

According to the first aspect, the article holder comprises: the holder main body having the holding portion capable of detachably holding the article; the fixation body arranged adjacent to and fixed to the holder main body and having the clamping portion capable of clamping part of the gripped portion of the vehicle equipment; and the lever body provided continuously with the fixation body so as to be able to open and close the clamping portion, and the fixation body, the lever body, and the holder main body are formed in such shapes that, in the state where an arbitrary part of the gripped portion is clamped by the clamping portion of the fixation body, another part of the gripped portion can be gripped by the hand. Since the holder main body and the fixation body to which the lever body is attached are arranged adjacent and directly joined to each other, the article holder is reduced in size as a whole and does not impair a grip function of the gripped portion of the vehicle equipment even when the article holder is fixed to the gripped portion. Accordingly, the article holder can be fixed to the vehicle equipment without any problem. In addition, since the elements (the fixation body, the lever body, and the holder main body) of the article holder are reduced in size and can be arranged close to each other around the vehicle equipment, the elements can be used also as sub-grips separate and independent from the gripped portion of the vehicle equipment and usability is thus excellent.

According to a second aspect, in addition to the first aspect, the fixation body is formed in a shape of a spherical body partially cut out and a cut-out surface of the fixation body is used as a joint surface with the holder main body.

According to the second aspect, since the fixation body is formed in a substantially semispherical shape and can be gripped easily as in a way of gripping a ball, functionality of the fixation body as a sub-grip is excellent. Furthermore, particularly in a state where the article is held by the holding portion of the holder main body, using the holder main body as the sub-grip is difficult, and usefulness of the fixation body as the sub-grip thus becomes higher.

According to a third aspect, in addition to the first or second aspect, the holder main body is formed in a shape of a spherical body partially cut out and a cut-out surface of the holder main body is used as a joint surface with the fixation body.

According to the third aspect, since the holder main body is formed in a substantially semispherical shape and can be gripped easily as in a way of gripping a ball, functionality of the holder main body as a sub-grip is excellent. Hence, the holder main body can be effectively used as the sub-grip in a state where no article is held by the holding portion of the holder main body.

According to a fourth aspect, in addition to any one of the first to third aspects, joint surfaces respectively of the fixation body and the holder main body are integrally joined to each other in a back-to-back state where the joint surfaces face each other, such that the fixation body and the holder main body form a spherical shape as a whole.

According to the fourth aspect, the joint surfaces respectively of the fixation body and the holder main body are integrally joined to each other in the back-to-back state where the joint surfaces face each other, such that the fixation body and the holder main body form a spherical shape as a whole and can be gripped more easily. Hence, in the state where no article is held by the holding portion of the holder main body, the hand can be put simultaneously on both of the fixation body and the holder main body. The fixation body and the holder main body can be thus used as a relatively large sub-grip and easily gripped from any direction and the usability is thereby improved.

According to a fifth aspect, in addition to any one of the first to fourth aspects, the joint surfaces respectively of the fixation body and the holder main body are detachably joined to each other.

According to the fifth aspect, the joint surfaces of the fixation body and the holder main body are detachable and attachable. Accordingly, when the holder main body breaks, the matter can be easily handled by replacing the holder main body with a new one. Furthermore, the holder main body can be replaced with another holder main body for holding another type of article. Various types of article holders can be thus selectively used in the vehicle compartment and convenience is further improved.

According to a sixth aspect, in addition to any one of the first to fifth aspects, an engagement recess portion for hooking the article is formed in at least one side edge portion of the lever body.

According to the sixth aspect, since the engagement recess portion for hooking the article is formed in at least the one side edge portion of the lever body, hooking of a handle and the like of a bag such as a shopping bag can be easily achieved in a simple structure using the lever body and the convenience is further improved. Moreover, forming the engagement recess portions particularly in opposite side edge portions of the lever body allows a shopping bag and the like to be hooked on the lever body even when posture of the lever body is turned upside down.

According to a seventh aspect, in addition to any one of the first to sixth aspects, the holding portion is formed of a recess portion which is formed in the holder main body to be open to an outer surface of the holder main body and which is capable of holding the article pushed into the recess portion, and a cut allowing a wall portion of the holder main body around the recess portion to elastically deform to expand is formed in the holder main body to be open to an inner surface of the recess portion.

According to the seventh aspect, the holding portion for the article is formed of the recess portion recessed from the outer surface of the holder main body. This prevents the holding portion from becoming bulky and can prevent an increase in size of the holder main body. Moreover, in the holder main body, the cut allowing the wall portion of the holder main body around the recess portion to elastically deform to expand is formed to be open to the inner surface of the recess portion. Accordingly, when the article is pushed into and held by the holding portion or when the article is pulled and taken out from the holding portion, the wall portion of the holder main body around the holding portion can be easily deformed to expand and operability of attaching and detaching the article by the holding portion can be improved.

According to a eighth aspect, in addition to any one of the first to seventh aspects, the joint surfaces respectively of the fixation body and the holder main body are joined to each other in such a way that positions of the joint surfaces relative to each other are adjustable about an axis orthogonal to the joint surfaces.

According to the eighth aspect, since the joint surfaces respectively of the fixation body and the holder main body are joined to each other in such a way that the positions of the joint surfaces relative to each other are adjustable about the axis orthogonal to the joint surfaces, the position of the holder main body relative to the fixation body fixed to the gripped portion of the vehicle equipment can be arbitrarily adjusted about the axis. Accordingly, attachment posture of the holder main body as well as holding posture of the article can be more appropriately set.

It is noted that, “spherical body” and “spherical” are not limited to a sphere in specific meaning. Specifically, “spherical body” and “spherical” are wide concepts including solids round as a whole and having shapes close to a sphere (for example, an oblate spheroid, an ellipsoid, a barrel-shaped solid, a spindle-shaped solid, a cocoon-shaped solid, and the like).

The above and other objects, characteristics and advantages of the present invention will be clear from detailed descriptions of the preferred embodiments which will be provided below while referring to the attached drawings.

### BRIEF DESCRIPTION OF THE DRAWINGS

The advantages of the invention will become apparent in the following description taken in conjunction with the drawings, wherein:

FIG. 1 is a perspective view showing a periphery of an entrance of an automobile in a state where an umbrella holder in a first embodiment is attached to an assist grip;

FIG. 2 is an overall perspective view of the umbrella holder in the first embodiment (enlarged perspective view in a direction of an arrow 2 in FIG. 1);

FIG. 3 is a front view of the umbrella holder in the first embodiment (view in a direction of an arrow 3 in FIG. 2);

FIG. 4 is a sectional view taken along a line 4-4 in FIG. 3;

FIG. 5 is a sectional view corresponding to FIG. 4 and showing a free state where the umbrella holder in the first embodiment is separated from the assist grip;

FIG. 6 is an exploded perspective view of the umbrella holder in the first embodiment;

FIGS. 7A to 7F are schematic perspective views showing several usage modes of the umbrella holder in the first embodiment;

FIGS. 8A and 8B are exploded perspective views of main portions of umbrella holders in second and third embodiments, respectively (corresponding to FIG. 6); and

FIGS. 9A and 9B are exploded perspective views of main portions of umbrella holders in fourth and fifth embodiments of the present invention, respectively (corresponding to FIG. 6).

### DETAILED DESCRIPTION OF THE INVENTION

Embodiments of the present invention are specifically described below by using the attached drawings.

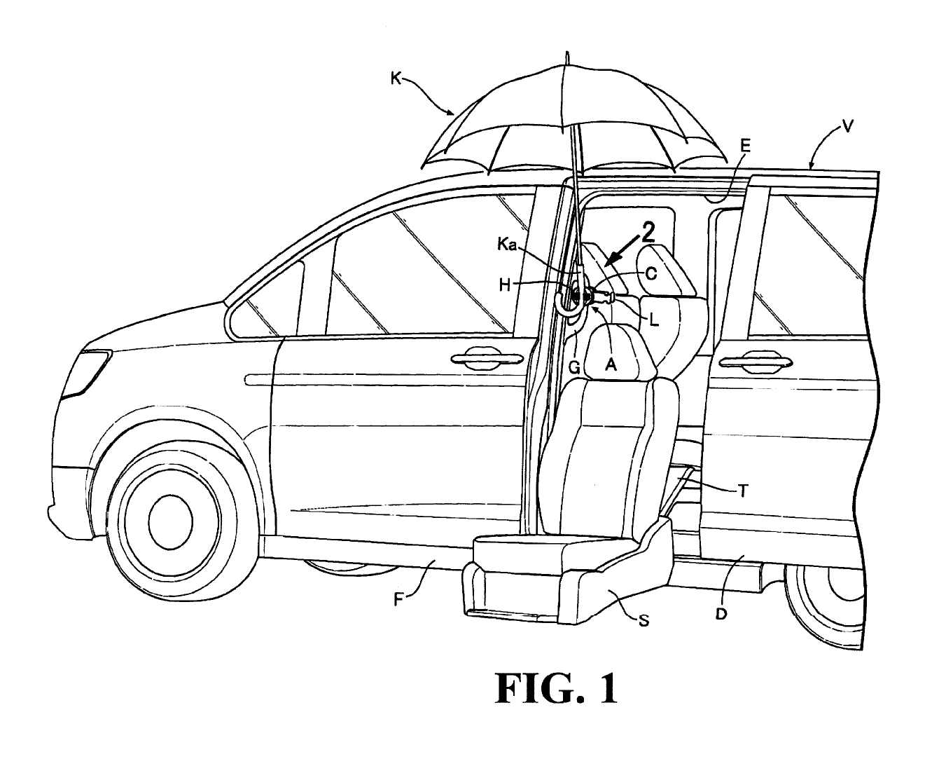

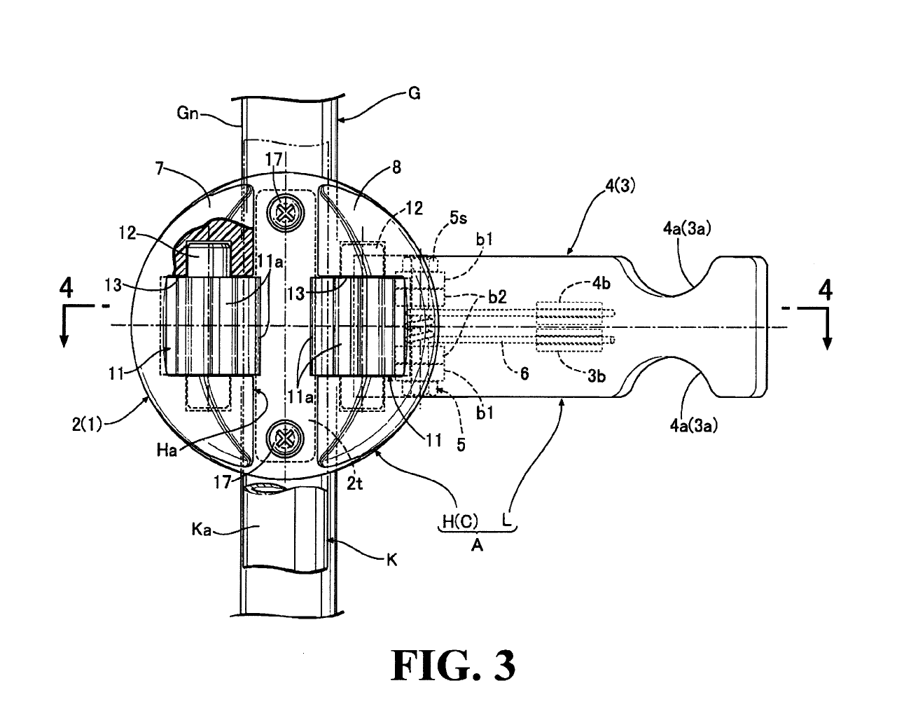

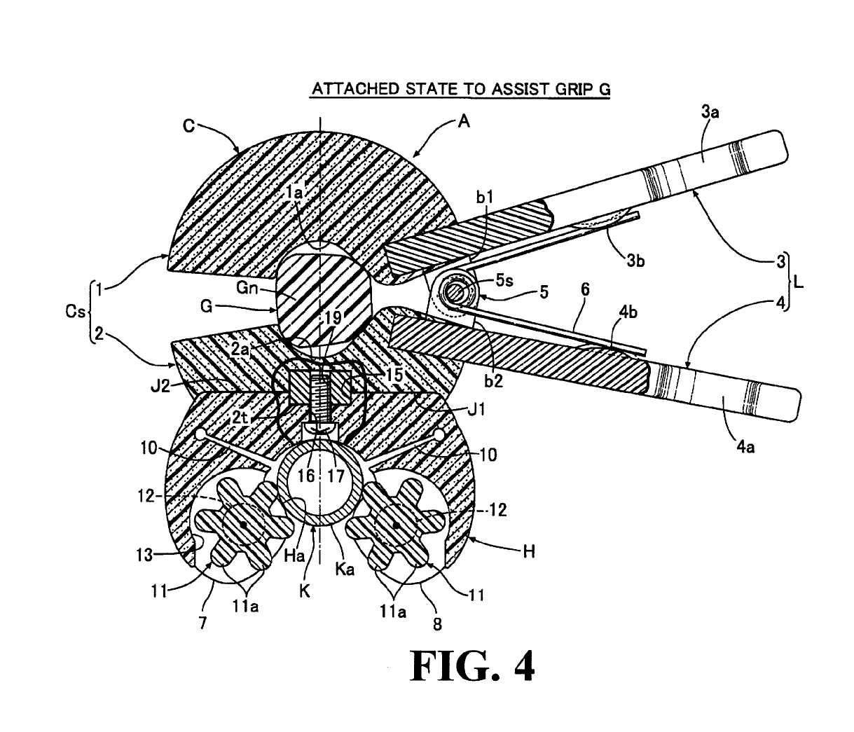

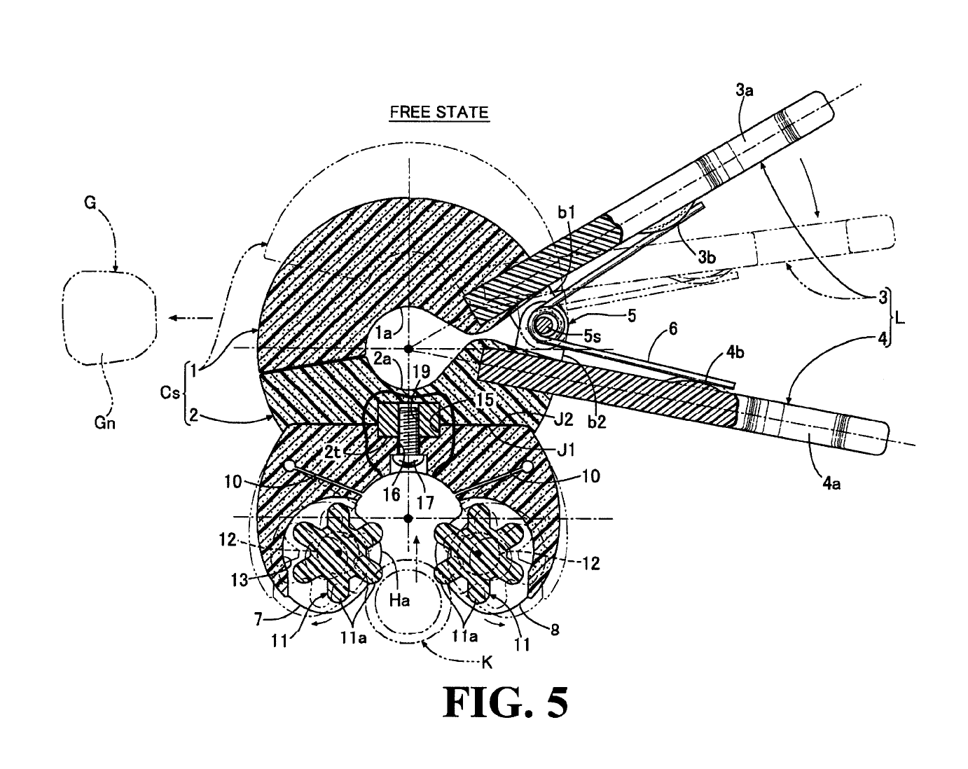

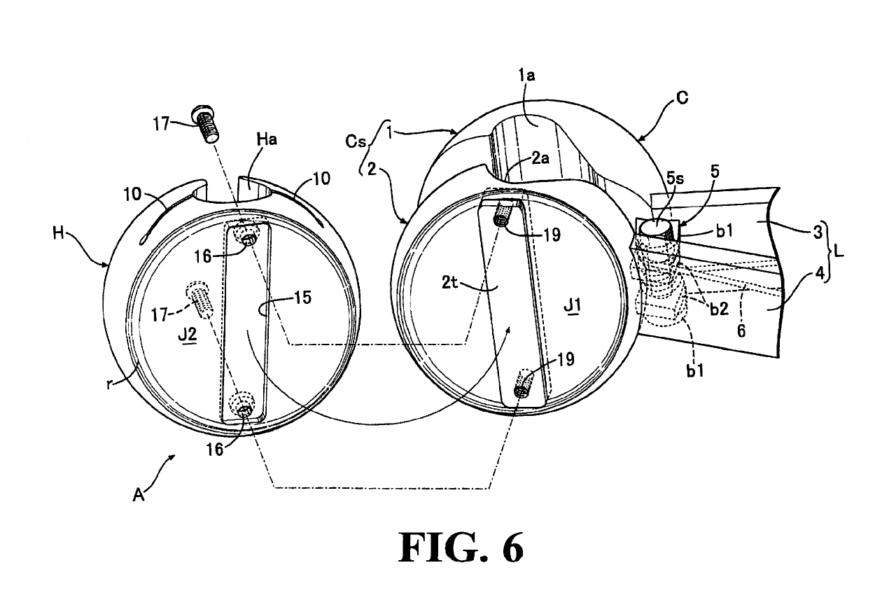

FIGS. 1 to 7F show a first embodiment of an umbrella holder which is an article holder. As illustrated in FIG. 1, an automobile V to which the umbrella holder A is attached is a minivan type automobile in which an entrance E openable and closable by a sliding door D is opened on at least one of left and right side surfaces of a vehicle body F. An assist grip G, which is vehicle equipment and which a passenger grips with his/her hand in ingress and egress to support his/her body, is provided near the entrance E.

In the embodiment, a second-row seat S provided lateral to the entrance E is supported by a vehicle body floor via a conventionally well-known seat moving device T. The seat S can be moved through the entrance E as needed between a normal riding position facing forward in the vehicle and an egress position facing laterally outside the vehicle (position shown by solid lines in FIG. 1), and is useful particularly for ingress and egress of a person requiring care. Note that the present invention can be applied to a normal automobile in which no such seat moving device T is mounted and the seat S is placed in a posture always facing forward.

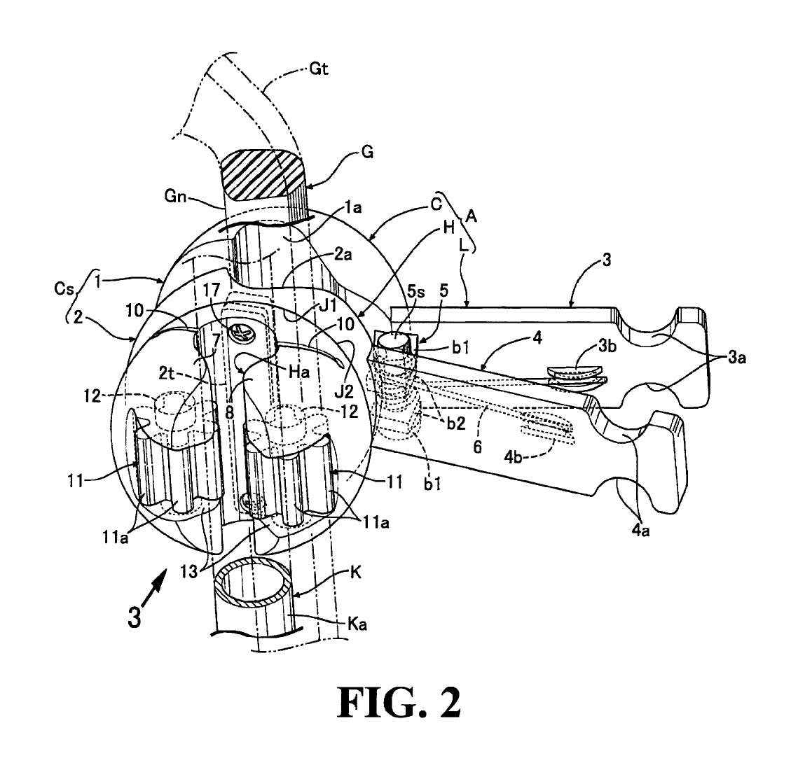

The assist grip G includes: a gripped portion Gn which extends substantially linearly along an opening peripheral edge of the entrance E and which is grippable by the hand; and paired upper and lower attachment arm portions Gt curving respectively from opposite ends of the gripped portion Gn toward the opening peripheral edge of the entrance E. The attachment arm portions Gt are fixedly attached to the vehicle body F (for example, to a center pillar) in the opening peripheral edge of the entrance E. The umbrella holder A is detachably attached to the gripped portion Gn of the assist grip G. Next, the structure of the umbrella holder A is described with reference also to FIGS. 2 to 6.

The umbrella holder A includes: a holder main body H which has a holding portion Ha capable of detachably holding an umbrella K being an article; a fixation body C which is disposed adjacent and fixed to the holder main body H and which has a clamping portion Cs capable of clamping part of the gripped portion Gn of the assist grip G; and a lever body L which is provided to be continuous with the fixation body C so as to be able to open and close the clamping portion Cs of the fixation body C.

The fixation body C, the lever body L, and the holder main body H are formed in such shapes that, in a state where an arbitrary portion of the gripped portion Gn of the assist grip G is clamped by the clamping portion Cs of the fixation body C, another portion of the gripped portion Gn can be gripped by the hand (i.e. such compact shapes that these bodies do not hinder gripping of the other portion by the hand). For example, in the illustrated example, the fixation body C is formed in a shape of a spherical body partially cut out (i.e. a substantially semispherical shape) and a cut-out surface of the fixation body C is used as a joint surface J1 with the holder main body H. Moreover, the holder main body H is also formed in a shape of a spherical body partially cut out (i.e. a substantially semispherical shape) and a cut-out surface of the holder main body H is used as a joint surface J2 with the fixation body C. The joint surfaces J1, J2 respectively of the fixation body C and the holder main body H are detachably joined to each other in a back-to-back state where the joint surfaces J1, J2 face each other, such that the fixation body C and the holder main body H form a spherical shape as a whole.

The fixation body C includes, as a main portion, first and second clamping portion half bodies 1, 2 which respectively have paired engagement grooves 1a, 2a clamping the gripped portion Gn of the assist grip G therebetween. The first and second clamping portion half bodies 1, 2 form the clamping portion Cs. The first and second clamping portion half bodies 1, 2 are molded from a material such as a hard rubber material and the like having a large surface friction coefficient, easily fitting in the hand, and being able to elastically deform to some extent, and the gripped portion Gn of the assist grip G can be firmly clamped between the first and second clamping portion half bodies 1, 2 without slipping.

The fixation body C is formed in the shape of the spherical body partially cut out (i.e. a substantially semispherical body) as described above, and the first and second clamping portion half bodies 1, 2 forming this fixation body C are formed in shapes obtained by dividing the semispherical body into two at a dividing surface extending substantially along the joint surface J1. On flat surfaces (divided surfaces) of the first and second clamping portion half bodies 1, 2 which face each other, the engagement grooves 1a, 2a are respectively provided to be recessed and to face each other.

Base portions of strip-shaped first and second lever half bodies 3, 4 respectively extending from respective sides of the first and second clamping portion half bodies 1, 2 in radial directions sharing the same center are integrally embedded in and fixed to the first and second clamping portion half bodies 1, 2, respectively. The lever half bodies 3, 4 are made of a hard synthetic resin material or the like.

A hinge connection mechanism 5 is provided between a coupled body of the first clamping portion half body 1 and the first lever half body 3 and a coupled body of the second clamping portion half body 2 and the second lever half body 4, the hinge connection mechanism 5 hinge-connecting the coupled bodies to each other in such a way that the coupled bodies can swing to open and close. The hinge connection mechanism 5 includes: hinge brackets b1, b2 provided in pairs on and protruded from a facing surface of each of the coupled bodies; and a hinge shaft 5s penetrating the hinge brackets b1, b2 and being supported by the hinge brackets b1, b2.

A torsion coil spring 6 which is a biasing means for elastically biasing the first and second lever half bodies 3, 4 in an opening direction (i.e. in a direction in which the clamping portion half bodies 1, 2 are closed) is interposed between the first and second lever half bodies 3, 4 in such a way that an intermediate coil portion of the torsion coil spring 6 is wound around the hinge shaft 5s. The clamping portion half bodies 1, 2 are biased in the closing direction by biasing force of the torsion coil spring 6 via the lever half bodies 3, 4. Due to this, the gripped portion Gn of the assist grip G is clamped between the engagement grooves 1a, 2a of the clamping portion half bodies 1, 2 and is fixed. Meanwhile, when a closing operation of the lever half bodies 3, 4 is performed against the biasing force of the torsion coil spring 6, force of the operation forcefully opens the clamping portion half bodies 1, 2 and the fixation body C can be removed from the assist grip G. Spring receiving portions 3b, 4b with which opposite end portions of the torsion coil spring 6 come into contact and engage and which restrict lateral misalignment of the opposite end portions of the torsion coil spring 6 are provided integrally respectively with the first and second lever half bodies 3, 4.

In the embodiment, description is given of an example in which the hinge connection mechanism 5 is provided between the coupled body of the first clamping portion half body 1 and the first lever half body 3 (particularly, a connection portion between the two bodies 1, 3) and the coupled body of the second clamping portion half body 2 and the second lever half body 4 (particularly, a connection portion between the two bodies 2, 4), and the torsion coil spring 6 being the biasing means for biasing the first and second lever half bodies 3, 4 in the opening direction (i.e. the direction in which the first and second clamping portion half bodies 1, 2 are closed) is interposed between the first and second lever half bodies 3, 4. However, the hinge connection mechanism may be provided directly between the first and second lever half bodies 3, 4 or between the first and second clamping portion half bodies 1, 2. Moreover, the spring which is the elastic biasing means for biasing the first and second clamping portion half bodies 1, 2 in the closing direction may be directly interposed between the first and second clamping portion half bodies 1, 2 via no first and second lever half bodies 3, 4. In this case, the elastic biasing means is not limited to the torsion coil spring and may be a rod-shaped torsion bar, a compression coil spring, an extension coil spring, a leaf spring, or the like.

Moreover, engagement recess portions 3a, 4a for hooking the umbrella K are formed respectively in at least one side edge portion (opposite side edge portions in the illustrated example) of the lever body L, i.e. the first and second lever half bodies 3, 4. Due to this, hooking of a handle and the like of a bag such as a shopping bag can be easily achieved in a simple structure using the lever body L and convenience is improved. Moreover, forming the engagement recess portions 3a, 4a particularly in the opposite side edge portions of the lever body L (i.e. the lever half bodies 3, 4) allows a shopping bag and the like to be hooked on the lever body L even when posture of the lever body L is turned upside down.

Moreover, the holder main body H is made of hard rubber material and is formed in the shape of the spherical body partially cut out (i.e. a substantially semispherical body) as described above. A holding groove Ha which is a recess portion capable of detachably holding the umbrella K pushed into the recess portion is provided on an outer surface of a semispherical surface of the holder main body H to be recessed therefrom. This recess portion, i.e. the holding groove Ha, forms the holding portion. The holding portion for the umbrella K being formed of the recess portion (holding groove Ha) recessed from the outer surface of the holder main body H as described above prevents the holding portion from becoming bulky and can prevent an increase in size of the holder main body H.

Moreover, in wall portions of the holder main body H around the holding groove Ha (to be more specific, base portions of paired wall portions 7, 8 between which the holding groove Ha exists), there are formed slit-shaped cuts 10 allowing the wall portions 7, 8 to elastically deform to expand to a reasonable degree. Providing the cuts 10 allows the wall portions 7, 8 of the holder main body H around the holding groove Ha to easily elastically deform to expand when the umbrella K is pushed into and held by the holding groove Ha, and operability of attaching and detaching the umbrella K by the holding portion can be improved.

Furthermore, paired roller housing recess portions 13 are formed respectively in opening edge portions of the holding groove Ha of the holder main body H, and paired guide rollers 11 which allow the umbrella K to be smoothly pushed into and held by the holding groove Ha and which allow the umbrella K to be smoothly pulled and taken out from the holding groove Ha are housed respectively in the roller housing recess portions 13. The guide rollers 11 are rotatably supported as at 12 in peripheral portions of the holding groove Ha of the holder main body H. Each of the guide rollers 11 basically has a cylindrical shape and many guide protruding portions 11a for slip prevention are provided integrally on an outer peripheral surface of each of the guide rollers 11 to be arranged in a peripheral direction of the guide roller 11.

Next, a joining structure between the holder main body H and the fixation body C is specifically described. The joint surface J2 of the holder main body H out of the joint surfaces J1, J2 respectively of the fixation body C and the holder main body H which face each other is basically a flat circular surface, and a round surface r having an arc-shaped cross section is formed in an outer peripheral edge portion of the joint surface J2. The joint surface J1 of the fixation body C (i.e. the second clamping portion half body 2) is formed to have a bottom surface basically formed of a flat circular recessed surface so that the joint surface J2 of the holder main body H can be engaged shallowly with the joint surface J1. A rectangular engagement protruding portion 2t extending along the engagement groove 2a is protruded from a center portion of the joint surface J1. The engagement protruding portion 2t may be molded integrally with the joint surface J1 or may be formed by joining another member to the joint surface J1 as shown in the illustrated example. A rectangular recessed area 15 to come into recess-protrusion engagement with the engagement protruding portion 2t so as to be unrotatable relative thereto is formed in a center portion of the joint surface J2 of the holder main body H in such a way that a longitudinal direction of the recessed area 15 extends along a longitudinal direction of the holding groove Ha.

Moreover, paired bolt insertion holes 16 penetrating a bottom wall of the holding groove Ha and opened in the recessed area 15 are formed in one end portion and another end portion of the bottom wall in a groove longitudinal direction thereof. Meanwhile, paired screw holes 19 corresponding to the bolt insertion holes 16 are provided in the engagement protruding portion 2t. The holder main body H and the fixation body C (i.e. the second clamping portion half body 2) are detachably joined to each other by paired bolts 17 which are inserted from the holding groove Ha side through the bolt insertion holes 16 to be screwed and fastened to the screw holes 19 of the engagement protruding portion 2t. Note that a rotating operation of the bolts 17 is performed by engaging a tool with each of the bolts 17 through a space inside the holding groove Ha.

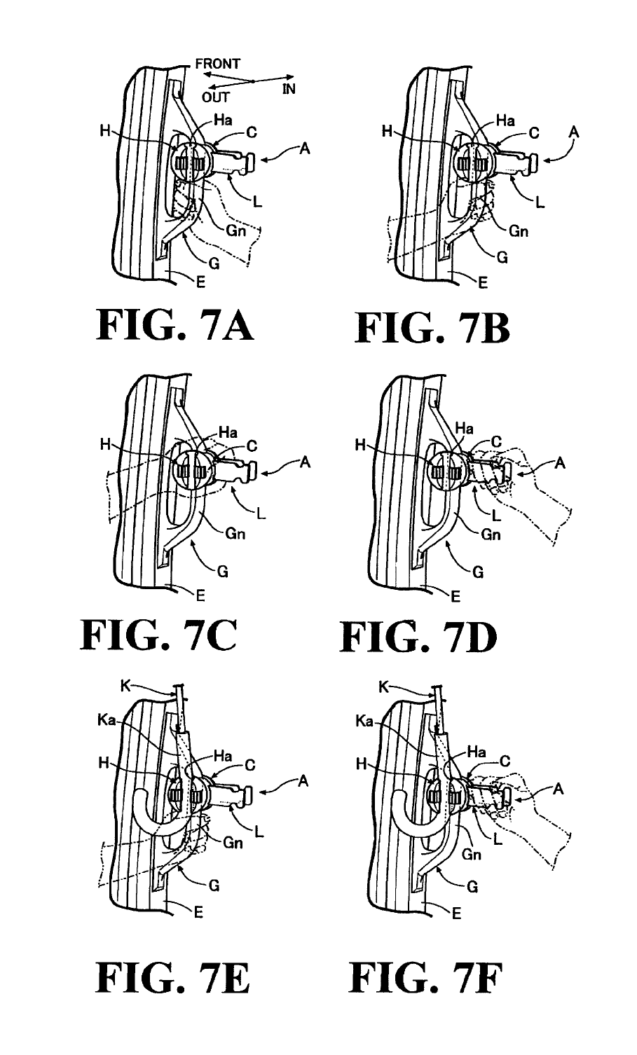

Next, operations of the embodiment are described by referring also to FIGS. 7A to 7F. When one of left and right sliding doors D of the automobile V is slid, as shown in FIG. 1, the entrance E is opened. In this opened mode of the entrance E, the second-row seat S provided lateral to the entrance E can be moved through the entrance E between the normal riding position facing forward in the vehicle and the egress position facing laterally outside the vehicle (position shown by solid lines in FIG. 1) by an action of the conventionally well-known seat moving device T.

In a case of using the umbrella holder A of the embodiment, the umbrella holder A is first attached to the assist grip G fixed to the vehicle body F (center pillar) on one side of the entrance E. Then, a handle portion Ka of the umbrella K is pushed into and fitted to the holding groove Ha of the holder main body H of the umbrella holder A and the umbrella K can be thereby fixed to and supported by the assist grip G in a state opened directly above the entrance E. This can effectively prevent a person getting on or off the vehicle through the entrance E from getting wet in rain and snow and from receiving direct sunlight. In attachment of the umbrella holder A, operation of opening the clamping portion Cs (i.e. the first and second clamping portion half bodies 1, 2) of the fixation body C can be performed by performing a gripping operation in a direction in which the first and second lever half bodies 3, 4 are brought closer to each other against the biasing force of the torsion coil spring 6. Accordingly, operation of clamping the assist grip G by the clamping portion Cs and fixing the clamping portion Cs to the assist grip G can be easily and appropriately performed and operability of attaching and detaching the umbrella holder A to and from the assist grip G is excellent.

As described above, in the embodiment, the fixation body C, the lever body L, and the holder main body H which are main constituent elements of the umbrella holder A are formed in such shapes that, in the state where an arbitrary portion (for example, an upper portion) of the gripped portion Gn of the assist grip G is clamped by the clamping portion Cs of the fixation body C, another portion (for example, a lower portion) of the gripped portion Gn can be gripped with the hand (particularly, the holder main body H and the fixation body C are formed in the substantially spherical compact shape as a whole). Moreover, the holder main body H and the fixation body C to which the lever body L is attached are directly connected to each other in a back-to-back adjacent state and size of the umbrella holder A as a whole is reduced. Accordingly, even when the umbrella holder A clamps the gripped portion Gn of the assist grip G and thereby fixed to the gripped portion Gn, there is no risk of the umbrella holder A impairing a grip function of the gripped portion Gn. Hence, the umbrella holder A can be fixed to the assist grip G without any problem.

Specifically, as illustrated in FIGS. 7A and 7B, in a state where the upper portion of the gripped portion Gn of the assist grip G is clamped by the clamping portion Cs of the fixation body C of the umbrella holder A, the lower portion of the gripped portion Gn is in a state open to its surrounding. Hence, the person getting on and off the automobile can grip the lower portion of the gripped portion Gn from an inside of a vehicle compartment and an outside of the vehicle without any problem, and smooth ingress and egress operations are made possible.

In addition, since the elements (the fixation body C, the lever body L, and the holder main body H) of the umbrella holder A are reduced in size and can be arranged close to each other around the assist grip G, the elements C, L, and H can be used also as sub-grips separate and independent from the gripped portion Gn of the assist grip G and usability is thus excellent. For example, FIG. 7C illustrates a usage mode where the person getting on and off the vehicle grips at least the holder main body H (in the illustrated example, in a way gripping also the fixation body C) while, FIG. 7D illustrates a usage mode where the person getting on and off the vehicle grips the lever body L (i.e. the lever half bodies 3, 4), in a state where the holder main body H holds no umbrella K.

Moreover, FIG. 7E shows that, even in a state where the holder main body H holds the umbrella K, the person getting on and off the vehicle can grip the lower portion of the gripped portion Gn from the inside of vehicle compartment and the outside of the vehicle as in FIGS. 7A and 7B described above without any problem. Furthermore, FIG. 7F shows that, even in the state where the holder main body H holds the umbrella K, the person getting on and off the vehicle can grip the lever body L (i.e. the lever half bodies 3, 4) without any problem.

Moreover, in the embodiment, since the fixation body C is formed in the substantially semispherical shape and can be gripped easily as in a way of gripping a ball, functionality of the fixation body C as the sub-grip is excellent. Furthermore, particularly in the state where the umbrella K is held by the holder main body H, using the holder main body H as the sub-grip is difficult, and usefulness of the fixation body C as the sub-grip thus becomes higher. Meanwhile, since the holder main body H is also formed in the substantially semispherical shape and can be gripped easily as in a way of gripping a ball, functionality of the holder main body H as the sub-grip is excellent and the holder main body H can be effectively used as the sub-grip particularly in the state where no umbrella K is held by the holder main body H.

In addition, the joint surfaces J1, J2 respectively of the fixation body C and the holder main body H are integrally joined to each other in a back-to-back state where the joint surfaces J1, J2 face each other, such that the fixation body C and the holder main body H form a spherical shape as a whole and can be gripped more easily as in a way of gripping a ball. Hence, in the state where no umbrella K is held by the holding groove Ha of the holder main body H, the hand can be put simultaneously on both of the fixation body C and the holder main body H as illustrated in FIG. 7C. The fixation body C and the holder main body H can be thus used as a relatively large sub-grip and easily gripped from any direction and the usability is thereby excellent.

Moreover, particularly in the embodiment, there is employed a joining structure in which the joint surfaces J1, J2 of the fixation body C and the holder main body H are detachably fitted and attached to each other by using the bolts 17. Accordingly, attaching and detaching operations of the fixation body C and the holder main body H can easily performed with sufficient joining strength being secured therebetween. In addition, when the holder main body H breaks, the matter can be easily handled at a low cost only by replacing the holder main body H with a new one. Furthermore, another holder main body which holds a different type of article (for example, a drink cup or the like) and which can be joined to the fixation body C may be prepared. This allows the holder main body H to be replaced with the other holder main body as needed. Various types of article holders can be thus selectively used in the vehicle compartment and convenience is further improved.

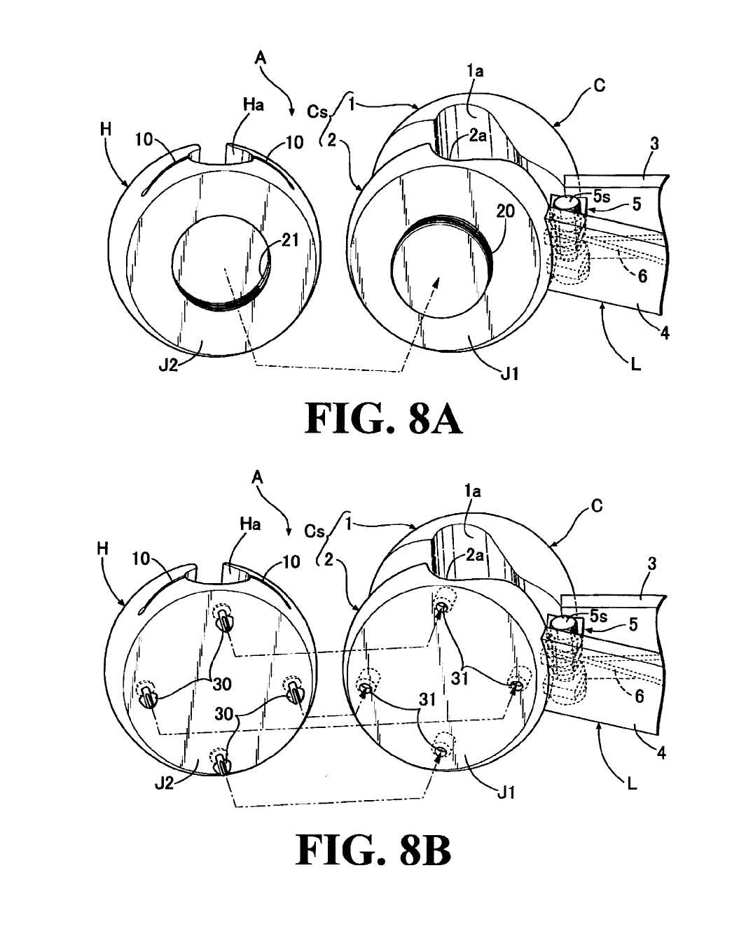

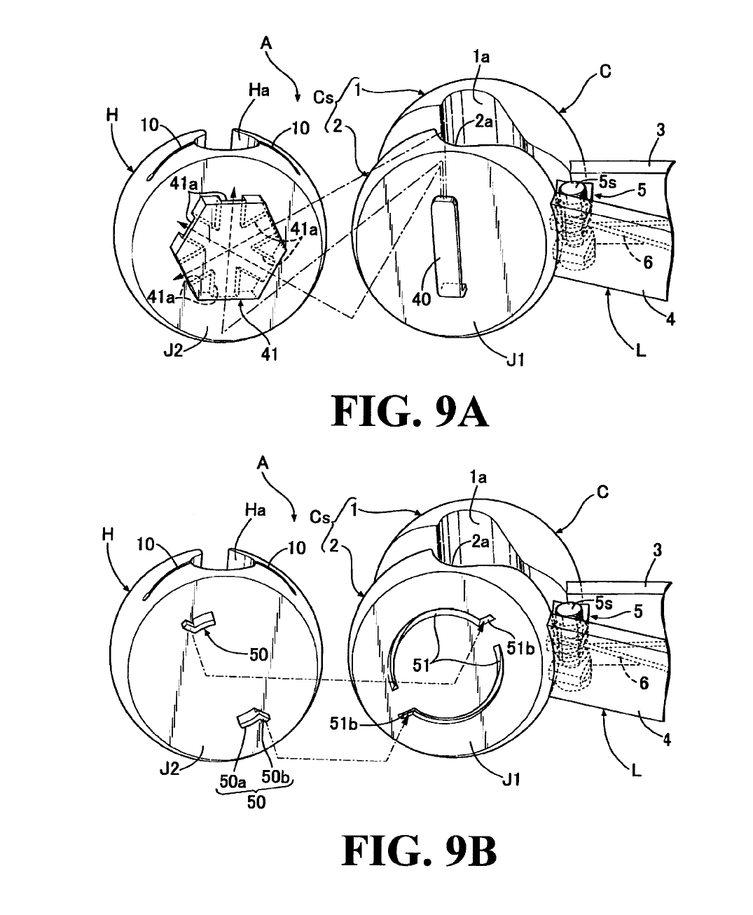

FIGS. 8A and 8B, respectively, illustrate second and third embodiments and FIGS. 9A and 9B, respectively, illustrate fourth and fifth embodiments. The second to fifth embodiments are different from the first embodiment only in the joining structure between the joint surfaces J1, J2 of the fixation body C and the holder main body H, and the joining structures of these embodiments are described below one by one. Note that, in the second to fifth embodiments, constituent elements corresponding to the constituent elements of the first embodiment are denoted by the same reference signs as the first embodiment.

First, in the second embodiment of FIG. 8A, the joint surfaces J1, J2 respectively of the fixation body C and the holder main body H which are formed as flat surfaces are made to abut on each other on one flat plane, and a male screw shaft portion 20 is formed in a center portion of one joint surface J1 out of the joint surfaces J1, J2 while a female screw hole 21 to which the male screw shaft portion 20 is screwed is provided in a center portion of the other joint surface J2. The male screw shaft portion 20 is screwed to the female screw hole 21 and the joint surfaces J1, J2 of the fixation body C and the holder main body H are thereby detachably joined to each other.

In the third embodiment of FIG. 8B, the joint surfaces J1, J2 respectively of the fixation body C and the holder main body H which are formed as flat surfaces are made to abut on each other on one flat plane, and multiple elastic protruding portions 30 capable of elastically deforming are provided in or near an outer peripheral portion of one joint surface J2 out of the joint surfaces J1, J2, at equal intervals in a peripheral direction, to protrude therefrom. Moreover, multiple engagement holes 31 with which the respective multiple elastic protruding portions 30 elastically engage are provided in or near an outer peripheral portion of the other joint surface J1, at equal intervals in the peripheral direction.

By pushing each of the elastic protruding portions 30 into any one of the engagement holes 31 and elastically locking the elastic protruding portions 30 to the engagement holes 31, the joint surfaces J1, J2 of the fixation body C and the holder main body H are detachably joined to each other in such a way that positions of the joint surfaces J1, J2 relative to each other are adjustable about an axis orthogonal to center portions of the joint surfaces J1, J2. Moreover, by making joining positions of the joint surfaces J1, J2 of the fixation body C and the holder main body H relative to each other adjustable about the axis as described above, a position of the holder main body H relative to the fixation body C attached to the assist grip G is made adjustable stepwise (at intervals of 90° in the illustrated example) about the axis as needed. Accordingly, attachment posture of the holder main body H as well as holding posture of the umbrella K can be more appropriately set by adjusting the relative position.

In the fourth embodiment of FIG. 9A, the joint surfaces J1, J2 respectively of the fixation body C and the holder main body H which are formed as flat surfaces are made to abut on each other on one flat plane, and a L-shaped protruding portion 40 is provided at a position slightly offset from a center portion of one joint surface J1 out of the joint surfaces J1, J2, the protruding portion 40 having a tip portion extending along the joint surface J1. Moreover, a flat regular-polygonal supporting protruding portion 41 is protruded from a center portion of the other joint surface J2, the supporting protruding portion 41 having multiple engagement holes 41a to which the L-shaped protruding portion 40 is selectively and slidably fitted. The multiple engagement holes 41a are arranged in a radial shape to intersect each other in the supporting protruding portion 41.

By slidably inserting the L-shaped protruding portion 40 into one of the engagement holes 41a of the supporting protruding portion 41, the joint surfaces J1, J2 of the fixation body C and the holder main body H are detachably joined to each other in such a way that the positions of the joint surfaces J1, J2 relative to each other are adjustable about an axis orthogonal to the center portions of the joint surfaces J1, J2. Note that a state where the L-shaped protruding portion 40 is fitted to one of the engagement holes 41a of the supporting protruding portion 41 is maintained by friction force acting on fitting surfaces of these portions.

In the fifth embodiment of FIG. 9B, the joint surfaces J1, J2 respectively of the fixation body C and the holder main body H which are formed as flat surfaces are made to abut on each other on one flat plane, and at least a pair of engagement claw portions 50 are provided on one joint surface J2 out of the joint surfaces J1, J2 to be arranged in a peripheral direction of the joint surface J2. Each of the engagement claw portions 50 includes, for example, a claw main body 50a extending in an arc shape in the peripheral direction of the joint surface J2 and a hook portion 50b provided continuously and integrally with one end of the claw main body 50a. Meanwhile, at least a pair of engagement holes 51 with which the engagement claw portions 50 are detachably engaged are provided on the other joint surface J1 to extend in an arc shape in a peripheral direction of the joint surface J1. A hook hole 51b to which the hook portion 50b can be inserted and from which the hook portion 50b can be taken out is formed at one end of each of the engagement holes 51. An inner wall of each of the engagement holes 51 is provided with a lock mechanism (not illustrated) with a lock spring which can lock and fix the lock claw portion 50 at multiple lock positions in the peripheral direction in sequence by pushing the lock claw portion 50 into the engagement hole 51 and then turning the lock claw portion 50 along the engagement hole 51. For example, a structure similar to a joining structure between a conventionally well-known lock claw of an electrical wiring plug and a plug engagement hole of an outlet to which the plug is fixed by pushing and turning the plug is used as the structure of the lock claw portion 50 and the engagement hole 51 (i.e. the lock mechanism).

By pushing the lock claw portion 50 into the engagement hole 51 and turning the lock claw portion 50 by a predetermined amount in the peripheral direction to lock the lock claw portion 50 at any one of the lock positions, the joint surfaces J1, J2 of the fixation body C and the holder main body H are detachably joined to each other in such a way that the positions of the joint surfaces J1, J2 relative to each other are adjustable about an axis orthogonal to center portions of the joint surfaces J1, J2.

Although the embodiments of the present invention have been described above, the present invention is not limited to these embodiments and various other embodiments can be employed within the scope of the present invention.

For example, in the embodiments described above, the umbrella holder A is given as an example of the article holder. However, the article holder of the present invention is not limited to the umbrella holder and may be any article holder (for example, a cup holder, a document holder, a lamp holder, and the like) which can be attached to the gripped portion of the vehicle equipment in the vehicle compartment. In this case, the article of the present invention is not limited to the umbrella K and is a cup, a document, a lamp, or the like which can be held by the holder.

Moreover, in the embodiments described above, the assist grip G near the sliding door is given as an example of the vehicle equipment having the gripped portion Gn. However, the vehicle equipment of the present invention is not limited to the assist grip near the sliding door and may be any vehicle equipment (for example, an assist grip near a front pillar, a grab rail on a ceiling, a seat back grip on a back surface of a front seat, a handle of a door on the vehicle compartment side, a headrest supporting bar supporting a headrest on a seat back in such a way that the headrest can be raised and lowered, and the like) installed in the vehicle compartment and having a gripped portion to which the article holder can be attached.

Furthermore, in the embodiments described above, there is shown an example in which the first and second lever half bodies 3, 4 of the lever body L and the first and second clamping portion half bodies 1, 2 of the fixation body C are each molded integrally from the hard synthetic resin. However, the first and second lever half bodies 3, 4 and the first and second clamping portion half bodies 1, 2 can be each formed of: a core member for reinforcement; and a rubber material or synthetic resin material integrally covering a surface of the core member. In this case, the core members respectively of the first lever half body 3 and the first clamping portion half body 1 may be molded integrally, and the rubber material or the synthetic resin material covering the integrally-molded core members may be integrally molded. Similarly, the core members respectively of the second lever half body 4 and the second clamping portion half body 2 may be molded integrally, and the rubber material or the synthetic resin covering the integrally-molded core members may be integrally molded.

Moreover, in the embodiments described above, there is shown an example in which the holder main body H is integrally molded from the hard rubber material. However, a core member for reinforcement may be integrally embedded in part of the holder main body H, for example, a bottom wall portion of the holding groove Ha.

Furthermore, in the embodiments described above, there is shown an example in which the joint surfaces J1, J2 respectively of the fixation body C and the holder main body H are made to come into recess-protrusion engagement or abut on each other on one flat plane and are detachably joined to each other by the bolts 17. However, the joint surfaces J1, J2 of the fixation body C and the holder main body H may be joined to each other by appropriate joining means (for example, adhering means, fusion bonding means, welding means, swaging means, and the like) in which the joint surfaces J1, J2 are joined in such a way that attachment and detachment is difficult or not easy.

Although a specific form of embodiment of the instant invention has been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention which is to be determined by the following claims.

We claim:

1. A vehicle article holder, comprising:
a holder main body comprising a holding portion configured to detachably hold an article;
a fixation body disposed adjacent to and fixed to said holder main body, said fixation body comprising a clamping portion configured to clamp part of a gripped portion of a vehicle equipment; and
a lever body provided continuously with said fixation body, said lever body being configured such that actuation of said lever body opens and closes said clamping portion,
wherein said vehicle article holder is configured to detachably attach to the gripped portion.

2. The vehicle article holder according to claim 1,
wherein said fixation body is formed in a shape of a spherical body having a partial cut out, and
wherein a cut-out surface of said fixation body is a joint surface with said holder main body.

3. The vehicle article holder according to claim 1,
wherein said holder main body is formed in a shape of a spherical body having a partial cut out, and
wherein a cut-out surface of said holder main body is a joint surface with said fixation body.

4. The vehicle article holder according to claim 2,
wherein said holder main body is formed in a shape of a spherical body having a partial cut out, and
wherein a cut-out surface of said holder main body is a joint surface with said fixation body.

5. The vehicle article holder according to claim 4, wherein respective joint surfaces of said fixation body and said holder main body are integrally joined to each other in a back-to-back state where said respective joint surfaces face each other, such that said fixation body and said holder main body form a spherical shape as a whole.

6. The vehicle article holder according to claim 4, wherein respective joint surfaces of said fixation body and said holder main body are detachably joined to each other.

7. The vehicle article holder according to claim 1, wherein an engagement recess portion for hooking the article is formed in at least one side edge portion of said lever body.

8. The vehicle article holder according to claim 1,
wherein said holding portion is a recess portion formed in said holder main body to be open to an outer surface of said holder main body, said recess portion being configured to hold the article when the article is pushed into said recess portion, and
wherein a cut is formed in said holder main body to be open to an inner surface of said recess portion, such that a wall portion of said holder main body around said recess portion can elastically deform to expand.

9. The vehicle article holder according to claim 4, wherein said respective joint surfaces of said fixation body and said holder main body are joined to each other such that positions of said respective joint surfaces are adjustable relative to each other about an axis orthogonal to said joint surfaces.

10. The vehicle article holder according to claim 4,
wherein one of said respective joint surfaces of said fixation body and said holder main body comprises an engagement protrusion portion, and
wherein the other of said respective joint surfaces of said fixation body and said holder main body comprises a recessed area into which said engagement protrusion portion is configured to fit.

11. The vehicle article holder according to claim 4,
wherein one of said respective joint surfaces of said fixation body and said holder main body comprises a male screw shaft portion, and
wherein the other of said respective joint surfaces of said fixation body and said holder main body comprises a female screw hole into which said male screw shaft portion is configured to fit.

12. The vehicle article holder according to claim 4,
wherein one of said respective joint surfaces of said fixation body and said holder main body comprises a plurality of elastic protruding portions, and
wherein the other of said respective joint surfaces of said fixation body and said holder main body comprises a plurality of engagement holes into which said plurality of elastic protruding portions is configured to fit.

13. The vehicle article holder according to claim 4,
wherein one of said respective joint surfaces of said fixation body and said holder main body comprises an L-shaped protruding portion, and
wherein the other of said respective joint surfaces of said fixation body and said holder main body comprises a supporting protruding portion comprising a plurality of engagement holes into which said L-shaped protruding portion is configured to fit.

14. The vehicle article holder according to claim 4,
wherein one of said respective joint surfaces of said fixation body and said holder main body comprises at least one engagement claw comprising a main body and a hook continuous with said main body, and
wherein the other of said respective joint surfaces of said fixation body and said holder main body comprises at least one engagement hole continuous with a hook hole, said engagement claw being configured to fit into said engagement hole and said hook hole.
